(19) United States
(12) Patent Application Publication
(10) Pub. No.: US 2026/0301749 A1
(43) Pub. Date: Oct. 1, 2026

(54) MULTI-MODAL SYNTHETIC VOICE DETECTION SYSTEM AND METHOD

(71) Applicant: AT&T Intellectual Property I, L.P., Atlanta, GA (US)

(72) Inventors: Antoine Diffloth, Sammamish, WA (US); Prince Paulraj, Coppell, TX (US); Sundaresan Manoharan, Plano, TX (US)

(73) Assignee: AT&T Intellectual Property I, L.P., Atlanta, GA (US)

(21) Appl. No.: 19/093,846

(22) Filed: Mar. 28, 2025

(51) Int. Cl. G10L 17/24; G10L 25/69

(52) U.S. Cl. CPC G10L 17/24; G10L 25/69

(57) ABSTRACT

Aspects of the subject disclosure may include, for example, a method of: receiving, by a processing system including a processor, an audio input from a caller of a call; using passive detection techniques to analyze, by the processing system, the audio input to extract acoustic features, spectral patterns, prosodic elements, and lexical characteristics; initiating, by the processing system, active engagement with the caller by generating an interactive challenge via an artificial intelligence (AI) agent; receiving, by the processing system, responses from the caller to the interactive challenge generated; processing, by the processing system, the responses using automatic speech recognition and natural language processing techniques to assess response timing, content coherence, and complexity; combining, by the processing system, the using of the passive detection techniques with an evaluation of the response of the caller to generate a composite synthetic voice detection score; and based on the composite synthetic voice detection score, determining, by the processing system, whether a voice of the caller is generated by artificial intelligence. Other embodiments are disclosed.

### FIELD OF THE DISCLOSURE

The subject disclosure relates to a multi-modal synthetic voice detection system and method.

### BACKGROUND

Researchers have studied the notion of intelligence in humans and the need to distinguish human intelligence from machine created artificial intelligence (AI) ever since the invention of the general-purpose computer. A classic example of this study is the Turing Test, proposed by the British mathematician and computer scientist Alan Turing in 1950. This test measures a machine's ability to exhibit intelligent behavior equivalent to, or indistinguishable from, that of a human. In the test, a human evaluator interacts with both a machine and a human through a computer interface, without knowing which is which. If the evaluator cannot reliably tell the machine from the human, the machine is said to have passed the test. In those days, AI rising to the level of human intelligence was mostly a thought experiment that appeared only in science fiction.

Recently, generative AI such as ChatGPT can largely pass a Turing Test administered via text interactions. Presently, speech recognition and generation have been combined with GPT's language abilities to create bots that can speak and listen like humans in live, real-time conversations. These developments offer bad actors an incredibly powerful tool to perpetrate swindles, fraud, robocalls and other illegal activities though the phone system. Hence, the FCC has ruled that using AI-generated synthetic voices in robocalls is illegal.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system for detecting non-human callers functioning within the communication network in accordance with various aspects described herein.

FIG. 2B is a block diagram illustrating an example, non-limiting embodiment of an AI agent for detecting non-human callers functioning within the communication network in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a multi-modal synthetic voice detection system and method. Other embodiments are described in the subject disclosure.

One or more aspects of the subject disclosure include a method of: receiving, by a processing system including a processor, an audio input from a caller of a call; using passive detection techniques to analyze, by the processing system, the audio input to extract acoustic features, spectral patterns, prosodic elements, and lexical characteristics; initiating, by the processing system, active engagement with the caller by generating an interactive challenge via an artificial intelligence (AI) agent; receiving, by the processing system, responses from the caller to the interactive challenge generated; processing, by the processing system, the responses using automatic speech recognition and natural language processing techniques to assess response timing, content coherence, and complexity; combining, by the processing system, the using of the passive detection techniques with an evaluation of the response of the caller to generate a composite synthetic voice detection score; and based on the composite synthetic voice detection score, determining, by the processing system, whether a voice of the caller is generated by artificial intelligence.

One or more aspects of the subject disclosure include a system, including: a communications interface configured to receive an audio input from a voice of a caller initiating a call; a processing system including a processor; and a memory that stores executable instructions that, when executed by the processing system, facilitate modules configured to perform operations, the modules include: a passive detection module configured to analyze the audio input to extract acoustic features, spectral patterns, prosodic elements, and lexical characteristics using passive techniques; an active engagement module comprising an active controller agent and at least one agent configured to initiate interactive challenges with the caller in real-time, wherein the interactive challenges including current event inquiries, logic puzzles, interruption handling tests, and requests for non-speech sounds; an automatic speech recognition module configured to transcribe responses from the caller; a natural language processing module configured to evaluate the responses for response timing, content coherence, complexity, and logical consistency; a composite score generator configured to combine outputs of the passive detection module and the active engagement module to derive a composite synthetic voice detection score; and a decision module configured to determine, based on the composite synthetic voice detection score, whether the voice of the caller is generated by artificial intelligence.

One or more aspects of the subject disclosure include a non-transitory machine-readable medium, comprising executable instructions that, when executed by a processing system including a processor, facilitate performance of operations, including: receiving an audio input from a voice of a caller; analyzing the audio input to extract acoustic features, spectral patterns, prosodic elements, and lexical characteristics using passive detection techniques; actively engaging in a conversation with the caller, wherein the conversation presents an interactive challenge; receiving responses from the caller to the interactive challenge; processing the responses to assess response timing, content coherence, and complexity using automatic speech recognition and natural language processing techniques; combining the passive detection techniques with an evaluation of the responses of the caller to generate a composite synthetic voice detection score; and based on the composite synthetic voice detection score, determining whether the voice of the caller is generated by artificial intelligence.

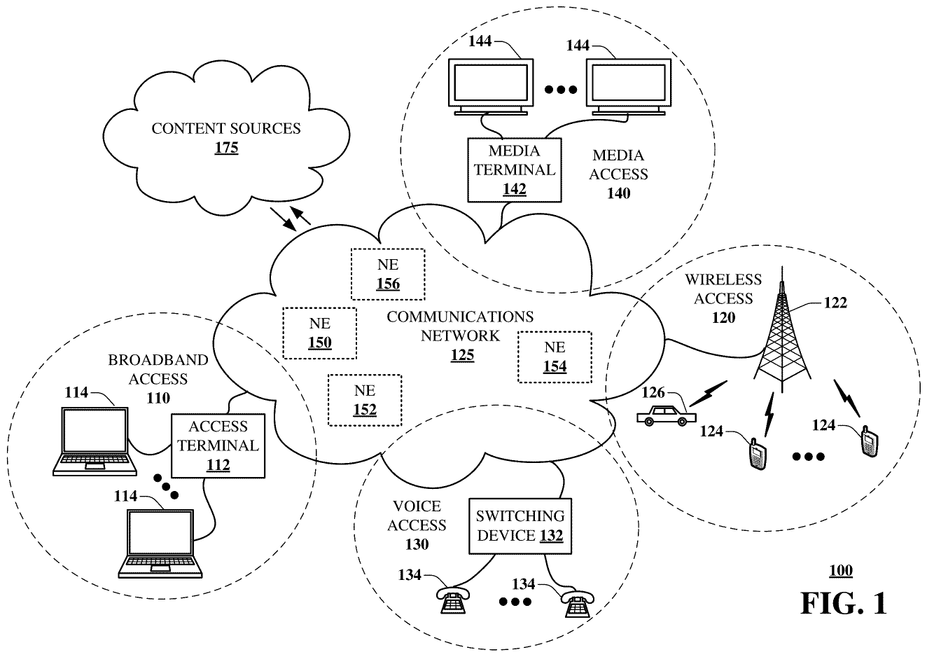

Referring now to FIG. 1, a block diagram is shown illustrating an example, non-limiting embodiment of a system 100 in accordance with various aspects described herein. For example, system 100 can facilitate in whole or in part receiving an audio input from a voice; extracting acoustic features, spectral patterns, prosodic elements, and lexical characteristics; challenging a caller; processing challenge responses to assess response timing, content coherence, and complexity using automatic speech recognition and natural language processing techniques; combining passive detection techniques with an evaluation of the responses of the caller to generate a composite synthetic voice detection score; and based on the composite synthetic voice detection score, determining whether the voice of the caller is generated by artificial intelligence. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

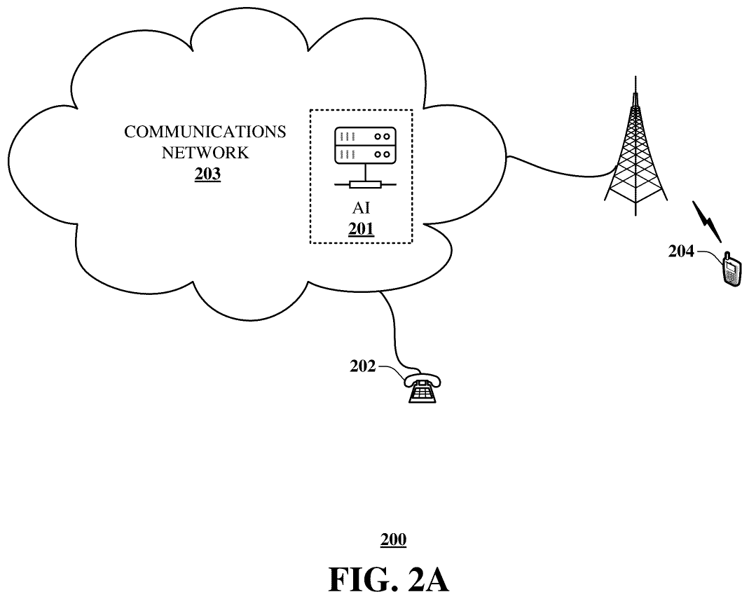

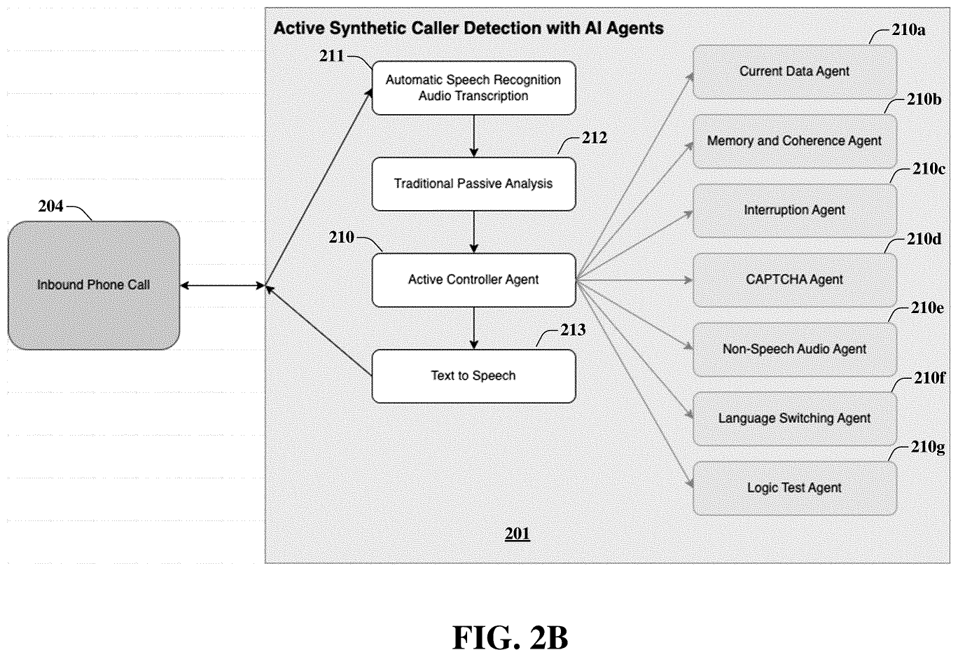

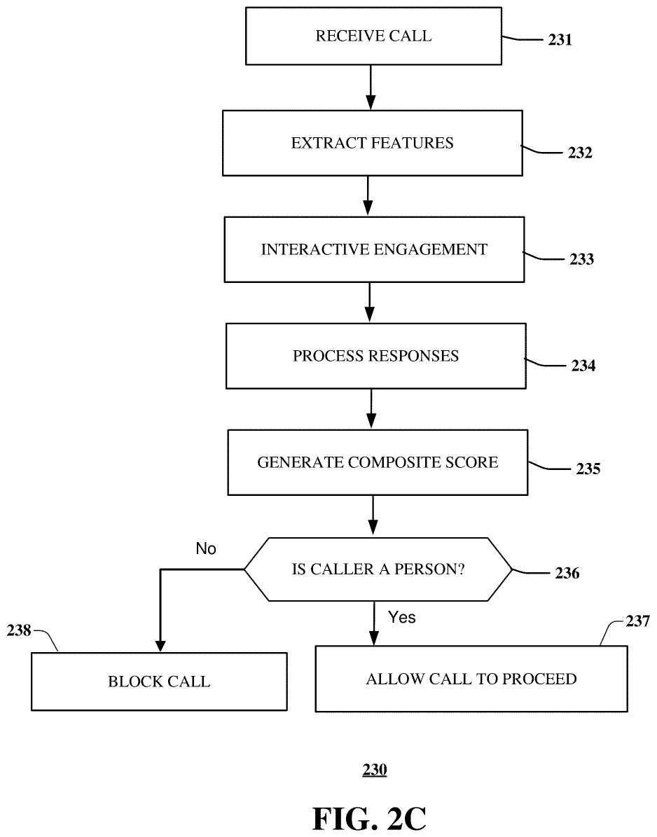

FIG. 2A is a block diagram illustrating an example, non-limiting embodiment of a system for detecting non-human callers functioning within the communication network in accordance with various aspects described herein. As shown in FIG. 2A, processing system 200 comprises a network element (AI 201), which acts as an intelligent agent for a callee 202 within the communications network 203. AI 201 is designed to actively engage with a caller 204 to determine whether the caller is using a synthetic voice. AI 201 is a principal component of processing system 200, leveraging advanced algorithms and machine learning techniques to analyze the caller's voice and interaction patterns.

Communications network 203 functions as the infrastructure that links the AI 201 with both the callee 202 and the caller 204. This network can encompass several types of communication technologies, such as cellular, VoIP, or traditional telephony systems, as set forth above in connection with FIG. 1, allowing for seamless interaction between AI 201 and the parties involved in the call. The network's role is significant as it supports the transmission of voice data and other relevant information needed for the AI to carry out detection tasks.

Callee 202 represents the recipient of the call within the system. Callee 202 is connected to the communications network 203, allowing AI 201 to monitor and analyze the call in real-time. AI 201 has the ability to interact with caller 204 and plays a significant role in gathering contextual information and ensuring that the detection process is accurate and efficient.

Caller 204 is the entity initiating the call, which may or may not be using a synthetic voice directed by an AI. The primary objective of processing system 200 is to assess voice characteristics and interaction style of caller 204 to determine the likelihood that caller 204 is a machine-generated entity. AI 201 employs various techniques, such as analyzing response times, voice modulation, and conversational coherence, to make this determination.

Overall, the system depicted in FIG. 2A represents an innovative approach to synthetic voice detection, combining active engagement with advanced AI 201 capabilities to enhance the accuracy and reliability of identifying non-human callers. The system is particularly significant in the context of preventing fraudulent activities and ensuring secure communication channels through communication network 203.

FIG. 2B is a block diagram illustrating an example, non-limiting embodiment of an AI agent for detecting non-human callers functioning within the communication network in accordance with various aspects described herein. As illustrated in FIG. 2B, a caller 204 is the entity initiating the phone call within the system. In this context, the caller 204 may be a human or a machine-generated entity using synthetic voice technology. The primary objective of the system is to assess the voice characteristics and interaction style of caller 204 to determine the likelihood that the caller is a machine-generated entity (a.k.a. an AI). This assessment is important for identifying potentially fraudulent activities and ensuring secure communication channels. Caller 204 interacts with AI 201, which is designed to actively engage with the caller to determine whether a synthetic voice is being used. The system employs various techniques, such as analyzing response times, voice modulation, and conversational coherence, to make this determination.

AI 201 serves as a principal component of the system, utilizing advanced algorithms and machine learning techniques to analyze the caller's voice and interaction patterns. This component functions as an intelligent agent within the communications network, designed to actively engage with caller 204. AI 201 employs a combination of Automatic Speech Recognition (ASR 211), Traditional Passive Analysis 212, and Text to Speech 213 to support the detection process.

In an embodiment, AI 201 coordinates the activities of various specialized agents, such as the Current Data Agent 210a, Memory and Coherence Agent 210b, Interruption Agent 210c, CAPTCHA Agent 210d, Non-Speech Audio Agent 210e, Language Switching Agent 210f, and Logic Test Agent 210g. These agents collaborate to assess the human-like quality of the caller's responses and evaluate the probability of a synthetic voice being used.

ASR 211 plays a significant role in converting the caller's spoken words into text. This transcription process is necessary for enabling further analysis by AI 201 and the related agents. ASR 211 allows the system to capture the nuances of the caller's speech, including tone, pacing, and word choice, which are then used to assess the likelihood of the caller being a machine-generated entity. The transcription also aids in facilitating the interaction between AI 201 and caller 204, allowing the AI to respond appropriately based on the caller's input. In an embodiment, ASR 211 has the ability to understand and transcribe non-speech sounds, e.g., a dog barking, hands clapping, whistling, noise from blowing on a microphone, etc.

The Traditional Passive Analysis 212 component is responsible for analyzing the transcribed audio data using conventional methods. This analysis includes evaluating acoustic features, spectral analysis, prosodic features, formant analysis, and lexical versus semantic analysis. Traditional Passive Analysis 212 also includes using convolutional neural networks (CNNs) to automatically learn to extract relevant features from spectrograms. These features can include patterns related to pitch, rhythm, and timbre. Traditional Passive Analysis 212 also includes using recurrent neural networks (RNNs) to process audio frames sequentially, maintaining a memory of previous frames to recognize patterns in speech; Long Short-Term Memories (LSTMs) to identify emotional states or distinguishing between different speakers over longer audio segments; and Transformers to handle entire sequences of audio data in parallel, using self-attention to focus on important parts of the audio. Other techniques include using embeddings and nearest neighbors to analyze the caller's speech. Traditional Passive Analysis 212 provides a baseline assessment of the caller's voice characteristics, which is then combined with the results from the active engagement approach to determine the likelihood of a synthetic voice being used. The system can use the baseline risk assessment provided by Traditional Passive Analysis 212 to determine which active detection methods to use and how aggressively to pursue active detection (by giving a starting point “best guess” assessment of the human-ness of the caller). This component is important in the overall detection process by providing additional context and supporting data for AI 201 and the associated agents.

The Active Controller Agent 210 orchestrates the detection process by coordinating the activities of various specialized agents. This agent is responsible for determining which tests to administer, the sequence of these tests, and the interpretation of the caller's responses. The Active Controller Agent 210 utilizes the results from the ASR 211 and Traditional Passive Analysis 212 to make informed decisions regarding the detection process. In an embodiment, Active Controller Agent 210 is an LLM-based AI agent that engages with the other agents in a flexible, agentic manner. The Active Controller Agent 210 mainly uses the results obtained by agents 210a-210g described below, combined with the baseline from Traditional Passive Analysis 212 to make a determination. The agent ensures that the system adapts to the caller's responses, adjusting the difficulty of the tests as needed to accurately assess the likelihood of a synthetic voice being used.

The Text to Speech 213 component is used to generate spoken responses from AI 201, allowing the system to actively engage with caller 204. This component plays a significant role in maintaining a natural and coherent conversation with the caller, enabling the AI to administer tests and gather contextual information. The Text to Speech 213 works in conjunction with the ASR 211 and Active Controller Agent 210 to facilitate real-time interaction with the caller, ensuring that the detection process is accurate and efficient. A key aspect of Text to Speech 213 is that responses must be context-sensitive and natural to make the caller feel comfortable, so that an accurate assessment of the caller can be made. Unnatural conversation may make a caller that is a real person become flagged as a machine. Getting human-like responses from humans is vital. Text to Speech 213 also has the ability to generate non-speech sounds, just like the ASR 211 has the ability to interpret them. This enables the system to conduct a test requiring human cognition of non-speech sounds, for example, “Please tell me what you hear?” and then ASR 211 plays a sound of rooster crowing.

The Current Data Agent 210a is responsible for evaluating the caller's knowledge of recent events and current data. This agent uses real-time information to challenge the caller's responses, assessing their ability to provide accurate and timely information. For example, the Current Data Agent 210a might ask the caller, “Did you hear about the hurricane that swept through Florida last week?” If the caller provides a response that is lengthy, is unable to answer, the answer contains a plethora of facts in a fashion unlike how a human would respond, or is inaccurate, then the Current Data Agent 210a would deem the caller to be directed by an AI. Such a response might be:
Yeah, I heard about it! Hurricane Milton hit Florida pretty hard last week. It made landfall as a category 3 storm, bringing intense winds, tornadoes, and flooding, especially around the Tampa and Sarasota areas. The storm left several people dead can cause major damage, including flooding in assistant living facilities and neighborhoods. Rescue operations were underway, and while it could have been worse, Florida still took a big hit. It is tough seeing the aftermath of these storms, but recovery is already in motion.
   The Current Data Agent 210a is important in identifying machine-generated entities, as these entities may struggle to keep up with rapidly changing information. LLMs only have knowledge of information that comes from training data. This training data necessarily has a cutoff date, which would require the fraudster using the synthetic voice to take extra steps to retrain the LLM on updated data in order to pass this test. A fraudster is unlikely to take this extra step.

The Memory and Coherence Agent 210b focuses on assessing the caller's ability to maintain a coherent conversation over multiple turns. This agent evaluates the caller's memory of previous interactions and their ability to integrate current information into the conversation. The role of the Memory and Coherence Agent 210b is to detect synthetic voices, as they may exhibit inconsistencies or contradictions in their responses. LLMs, especially the smaller and cheaper models that are likely to be used by fraudsters, have a weakness that they tend to forget earlier parts of the current conversation (let alone previous interactions). The incoherence can manifest within the same conversation, not only from previous, separate conversations. A way to test this would be to ask the caller to recall certain details that were discussed at the beginning of the conversation. Memory and Coherence Agent 210b could intentionally mention certain details at the beginning of the conversation that serve no purpose other than to test the recall ability of the caller.

The Interruption Agent 210c is designed to test the caller's ability to handle interruptions during the conversation. This agent evaluates the caller's response to sudden changes or interruptions in the conversation flow, assessing their ability to adapt and continue the interaction smoothly. The Interruption Agent 210c is particularly effective in identifying machine-generated entities, as they may struggle to recover from interruptions. For example, many cheaper, primitive AI bots will not notice an interruption mid-sentence but will keep on talking.

The CAPTCHA Agent 210d administers logic tests and challenges to the caller, similar to a CAPTCHA test on a website. This agent evaluates the caller's ability to solve common sense reasoning problems and respond to ambiguous language. The CAPTCHA Agent 210d plays a key role in detecting synthetic voices, as these voices may exhibit difficulties in handling these types of challenges.

The Non-Speech Audio Agent 210e focuses on identifying and requesting non-speech sounds from the caller. This agent evaluates the caller's ability to produce and recognize non-speech audio cues, such as background noise or environmental sounds. The Non-Speech Audio Agent 210e plays a significant role in detecting machine-generated entities, as these entities may struggle to replicate or interpret these types of sounds. Non-Speech Audio Agent 210e could play some pre-recorded sounds and ask the caller to identify them. Some example sounds include a dog barking, a car honking, rainfall, waves crashing, etc. The Non-Speech Audio Agent 210e could also ask the caller to generate non-speech sounds and can identify the sounds. Such sounds might include, for example, hand clapping, coughing, blowing air into the receiver of the phone's microphone, etc.

The Language Switching Agent 210f tests the caller's ability to switch between different languages during the conversation. This agent evaluates the caller's proficiency in multiple languages and their ability to seamlessly transition between them. The Language Switching Agent 210f is particularly effective in identifying synthetic voices, as they may exhibit unusual multi-lingual abilities or struggle with language transitions. Some commercially available LLMs can communicate in 50+ languages and will effortlessly switch between them. No human is capable of doing this.

The Logic Test Agent 210g administers one or more logic tests to the caller, evaluating their ability to solve complex reasoning problems. This agent assesses the caller's logical thinking and problem-solving skills, identifying any inconsistencies or errors in their responses. For example, Logic Test Agent 210g may ask a simple question, such as if you are carrying a cup of coffee and need to open a door, which hand do you use to grab the handle? If the caller responds with a long-winded answer, then the Logic Test Agent 210g may deem the caller to be synthetic. For example, a synthetic caller might provide an answer such as:
The hand you would use to open the door while carrying a cup of coffee typically depends on your dominant hand and personal preference. A few scenarios might include if you are right-handed in carrying a couple coffee in your right hand, you might open the door with your left hand. Conversely, if the coffee is in your left hand, you would likely use your right hand to open the door. On the other hand, if you are left-handed, the opposite would apply: you would open the door with your right hand if the coffee is in your left, or in your left hand if the coffee is in your right. In most cases people tend to hold the cup in their non dominant hand, so they can use their dominant hand to manipulate the door handle more easily.
   A human would provide a much simpler answer, such as “You would open the door with your other hand.”

The Logic Test Agent 210g might pose a follow-up question, such as, “Isn't the answer just ‘your other hand?’” If the caller quickly responds in a way that conforms, such as, “You are right! The simple answer is your other hand. If you are carrying a cup of coffee in one hand, you typically use the other hand to open the door. Simple and efficient!” then the Logic Test Agent 210g would deem the caller to be an AI. The Logic Test Agent 210g plays a significant role in detecting machine-generated entities, as these entities may exhibit certain logic mistakes that humans would not make. Presented with the follow-up question, LLMs tend to change their answers to agree with their human interlocutors with more willingness than most humans.

FIG. 2C depicts an illustrative embodiment of a method in accordance with various aspects described herein. As shown in FIG. 2C, method 230 begins with the step 231, which serves as the initial point of interaction in the synthetic voice detection system. This step involves the processing system 200 receiving an incoming call through the communications network 203. The system is designed to handle distinct types of calls, including those from traditional telephony systems, VoIP, or cellular networks. The reception of the call is important as it sets the stage for subsequent analysis and interaction. This step is foundational, as it ensures that the system is aware of the call and can begin the process of determining whether the caller is using a synthetic voice.

Following the reception of the call, the system proceeds to step 232. In this step, the processing system employs passive detection techniques to analyze the audio input from the caller. This involves extracting various acoustic features, such as spectral patterns, prosodic elements, and lexical characteristics. The system utilizes advanced algorithms to perform spectral analysis, prosodic feature extraction, and formant analysis. Additionally, convolutional neural networks (CNNs) may be used to analyze spectrograms, while recurrent neural networks (RNNs) and transformers can process sequences of audio data. This feature extraction is necessary for establishing a baseline understanding of the caller's voice characteristics, which will be used in conjunction with active detection methods to assess the likelihood of the voice being synthetic.

In the next step 233, the processing system actively engages with the caller through an AI 201. Unlike traditional passive detection methods, the system initiates interactive challenges designed to test whether the caller is a human. The AI 201 generates a series of interactive challenges, such as current event inquiries, logic puzzles, interruption handling tests, and non-speech sound requests. These challenges are strategically designed to exploit known weaknesses in AI models, such as difficulty handling questions or logic puzzles that are not anticipated. The interactive engagement is a dynamic process, with the AI 201 adapting the challenges based on the caller's responses to ensure a comprehensive assessment of the caller's voice.

Once the interactive engagement is underway, the system moves to step 234. In this step, the system analyzes the responses received from the caller using automatic speech recognition (ASR) and natural language processing (NLP) techniques. The system assesses various aspects of the responses, including response timing, content coherence, and complexity. ASR is used to transcribe the caller's spoken words into text, allowing for detailed analysis of the linguistic and semantic content. NLP techniques are employed to evaluate the coherence and logical consistency of the responses, as well as to detect any anomalies that may indicate a synthetic voice. This processing is crucial for integrating the results of the interactive engagement with the passive detection data to form a comprehensive evaluation of the caller's voice.

Next in step 235, the system combines the results from both the passive feature extraction and the active response processing to produce a composite synthetic voice detection score. This score represents the system's assessment of the likelihood that the caller's voice is generated by artificial intelligence. The composite score is calculated using a weighted combination of the various detection metrics, including acoustic features, response timing, and content coherence. The system may employ machine learning models 220 to optimize the weighting of these metrics, ensuring that the composite score accurately reflects the probability of a synthetic voice. This score is a significant output of the detection process, as it informs the subsequent decision-making step.

At decision point in step 236, the system evaluates the composite score to determine whether the caller's voice is likely to be human or synthetic. This decision relies on a predefined threshold, which can be adjusted based on the desired sensitivity and specificity of the detection system. If the composite score exceeds the threshold, the system concludes that the caller is likely using a synthetic voice. Conversely, if the score is below the threshold, the caller is deemed to be human. This decision point plays a significant role in ensuring that the system accurately identifies synthetic voices while minimizing false positives.

Depending on the outcome of the decision point in step 236, the system will either allow call to proceed in step 237 or block the call in step 238. If the caller is determined to be human, the system allows the call to proceed, ensuring that legitimate communications are not disrupted. This involves routing the call to the intended recipient or allowing the call to continue and connect with the callee without further intervention. On the other hand, if the caller is identified as using a synthetic voice directed by an AI, the system blocks the call from connecting with the callee to prevent potential fraudulent or malicious activities. This blocking action may involve terminating the call or redirecting the call to a security team for further investigation. The ability to block calls based on the detection of synthetic voices is an important feature of the system, providing a proactive defense against AI-generated swindles and fraud.

While for purposes of simplicity of explanation, the respective processes are shown and described as a series of steps in FIG. 2C, it is to be understood and appreciated that the claimed subject matter is not limited by the order of the steps, as some steps may occur in different orders and/or concurrently with other steps from what is depicted and described herein. Moreover, not all illustrated steps may be required to implement the methods described herein.

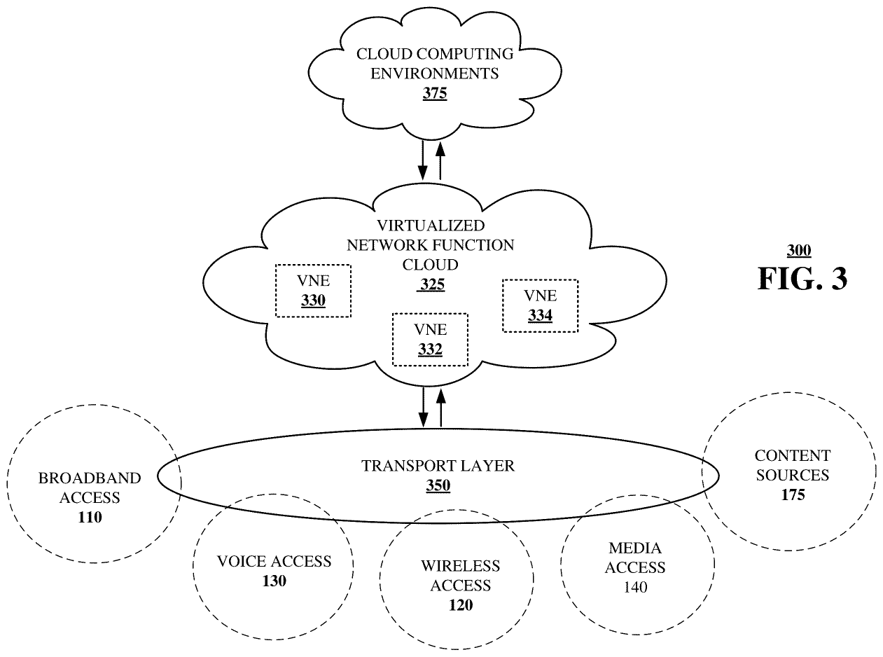

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of processing system 200, and method 230 presented in FIGS. 1, 2A, 2B, 2C and 3. For example, virtualized communication network 300 can facilitate in whole or in part receiving an audio input from a voice; extracting acoustic features, spectral patterns, prosodic elements, and lexical characteristics; challenging a caller; processing challenge responses to assess response timing, content coherence, and complexity using automatic speech recognition and natural language processing techniques; combining passive detection techniques with an evaluation of the responses of the caller to generate a composite synthetic voice detection score; and based on the composite synthetic voice detection score, determining whether the voice of the caller is generated by artificial intelligence.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. At other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

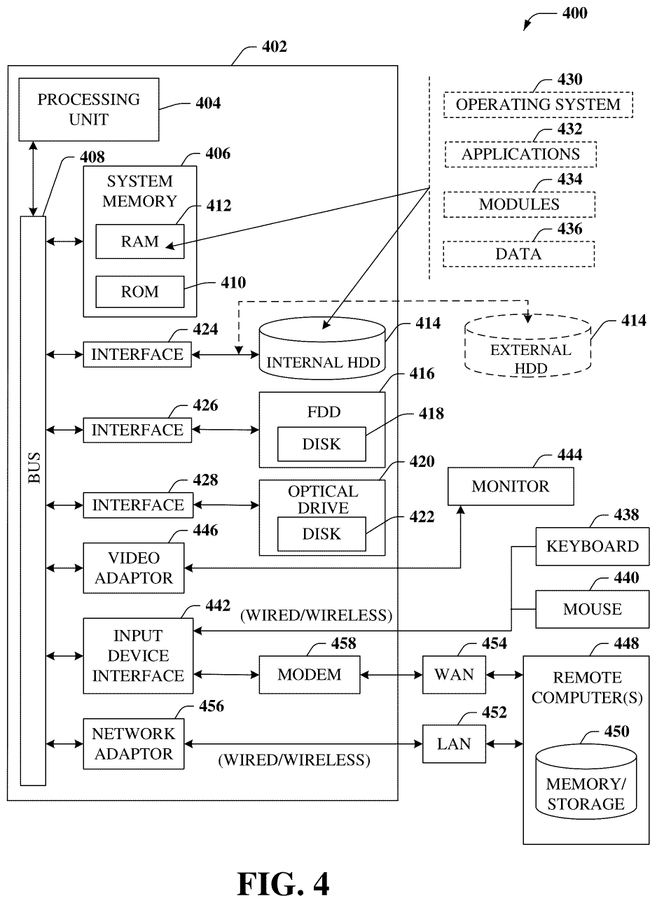

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a computing environment 400 suitable for implementing the various embodiments of the subject disclosure. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving an audio input from a voice; extracting acoustic features, spectral patterns, prosodic elements, and lexical characteristics; challenging a caller; processing challenge responses to assess response timing, content coherence, and complexity using automatic speech recognition and natural language processing techniques; combining passive detection techniques with an evaluation of the responses of the caller to generate a composite synthetic voice detection score; and based on the composite synthetic voice detection score, determining whether the voice of the caller is generated by artificial intelligence.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, programming modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can also be connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any means of communication, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, dependable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10 BaseT wired Ethernet networks used in many offices.

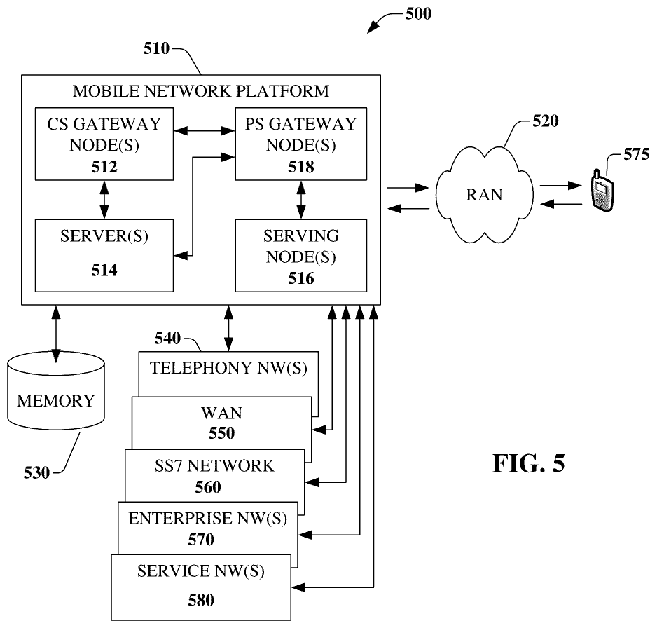

Turning now to FIG. 5, an embodiment 500 of a mobile network platform 510 is shown that is an example of network elements 150, 152, 154, 156, and/or VNEs 330, 332, 334, etc. For example, mobile network platform 510 can facilitate in whole or in part receiving an audio input from a voice; extracting acoustic features, spectral patterns, prosodic elements, and lexical characteristics; challenging a caller; processing challenge responses to assess response timing, content coherence, and complexity using automatic speech recognition and natural language processing techniques; combining passive detection techniques with an evaluation of the responses of the caller to generate a composite synthetic voice detection score; and based on the composite synthetic voice detection score, determining whether the voice of the caller is generated by artificial intelligence. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provide services from external network(s) like networks operated by a disparate service provider; for instance, WAN 550 or Global Positioning System (GPS) network(s) (not shown). Provisioning server(s) can also provision coverage through networks associated with mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates substantially in the same manner as described hereinbefore.

In embodiment 500, memory 530 can store information related to the operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

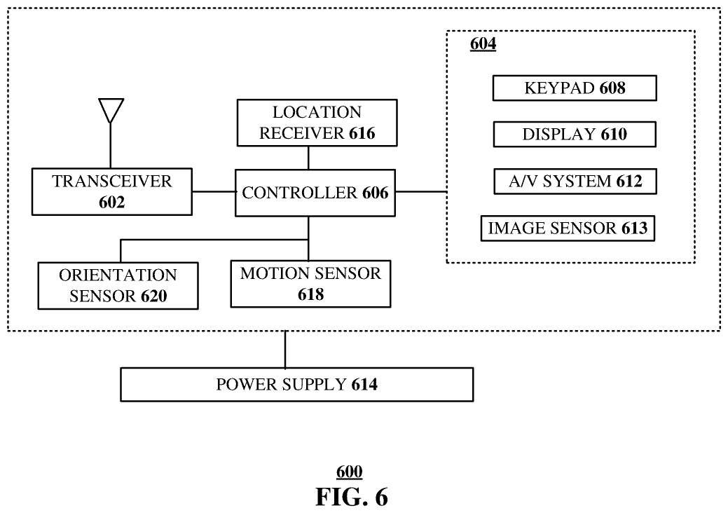

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving an audio input from a voice; extracting acoustic features, spectral patterns, prosodic elements, and lexical characteristics; challenging a caller; processing challenge responses to assess response timing, content coherence, and complexity using automatic speech recognition and natural language processing techniques; combining passive detection techniques with an evaluation of the responses of the caller to generate a composite synthetic voice detection score; and based on the composite synthetic voice detection score, determining whether the voice of the caller is generated by artificial intelligence.

The communication device 600 can comprise a wireline and/or wireless transceiver (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying the location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or non-volatile memory, or can comprise both volatile and nonvolatile memory, by way of illustration, and not limitation, volatile memory, non-volatile memory, disk storage, and memory storage. Further, nonvolatile memory can be included in read-only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some or all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can be executed from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications that can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, the use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more or less than all of the features described with respect to an embodiment can also be utilized.

What is claimed is:

1. A method, comprising:
receiving, by a processing system including a processor, an audio input from a caller of a call;
using passive detection techniques to analyze, by the processing system, the audio input to extract acoustic features, spectral patterns, prosodic elements, and lexical characteristics;
initiating, by the processing system, active engagement with the caller by generating an interactive challenge via an artificial intelligence (AI) agent;
receiving, by the processing system, responses from the caller to the interactive challenge generated;
processing, by the processing system, the responses using automatic speech recognition and natural language processing techniques to assess response timing, content coherence, and complexity;
combining, by the processing system, the using of the passive detection techniques with an evaluation of the response of the caller to generate a composite synthetic voice detection score; and
based on the composite synthetic voice detection score, determining, by the processing system, whether a voice of the caller is generated by artificial intelligence.

2. The method of claim 1, wherein the interactive challenge comprises current event inquiries, logic puzzles, interruption handling tests, non-speech sound requests, multi-language switching tests, multi-turn memory and coherence evaluations, or a combination thereof.

3. The method of claim 1, further comprising adjusting a difficulty level of the interactive challenge based on an analysis of the responses.

4. The method of claim 1, wherein the processing system further comprises an active controller agent configured to select one or more interactive challenges from a plurality of tests based on a continuously evaluated risk level associated with the responses of the caller.

5. The method of claim 1, further comprising employing, by the processing system, an automatic speech recognition module to transcribe the responses of the caller and a natural language processing module to assess semantic coherence, syntactic structure, and logical consistency of a transcription of the responses.

6. The method of claim 1, further comprising analyzing, by the processing system, a timing of the responses to identify delays and inconsistencies indicative of synthetic voice generation.

7. The method of claim 1, wherein the composite synthetic voice detection score is generated by combining weighted scores derived from the acoustic features, the spectral patterns, the prosodic elements, and a performance of the caller on the interactive challenge.

8. The method of claim 1, further comprising analyzing, by the processing system, a tone, a pitch, and a modulation of the voice of the caller and comparing characteristics to a reference database of human speech patterns.

9. The method of claim 1, wherein the interactive challenge is dynamically modified in real time based on a performance of the caller to tests designed to evaluate interruption handling, multi-turn memory and coherence, and a recognition or generation of non-speech audio cues.

10. The method of claim 1, wherein the active engagement further comprises generating, by the processing system, audible instructions via text-to-speech synthesis and receiving, by the processing system, corresponding audible responses for evaluation.

11. The method of claim 1, further comprising blocking, by the processing system, the call responsive to a first determination that the voice of the caller is generated by the artificial intelligence.

12. The method of claim 1, further comprising completing, by the processing system, the call responsive to a second determination that the voice of the caller is not generated by the artificial intelligence.

13. A system, comprising:
a communications interface configured to receive an audio input from a voice of a caller initiating a call;
a processing system including a processor; and
a memory that stores executable instructions that, when executed by the processing system, facilitate modules configured to perform operations, the modules comprising:
a passive detection module configured to analyze the audio input to extract acoustic features, spectral patterns, prosodic elements, and lexical characteristics using passive techniques;
an active engagement module comprising an active controller agent and at least one agent configured to initiate interactive challenges with the caller in real-time, wherein the interactive challenges including current event inquiries, logic puzzles, interruption handling tests, and requests for non-speech sounds;
an automatic speech recognition module configured to transcribe responses from the caller;
a natural language processing module configured to evaluate the responses for response timing, content coherence, complexity, and logical consistency;
a composite score generator configured to combine outputs of the passive detection module and the active engagement module to derive a composite synthetic voice detection score; and
a decision module configured to determine, based on the composite synthetic voice detection score, whether the voice of the caller is generated by artificial intelligence.

14. The system of claim 13, wherein the active engagement module further comprises a language switching agent configured to evaluate whether the caller changes between different languages during the interactive challenges, assess a proficiency in multiple languages of the caller, and evaluate whether the caller can seamlessly transition between the multiple languages.

15. The system of claim 13, wherein the active engagement module further comprises a memory and coherence agent configured to assess whether the caller can maintain a coherent conversation over multiple turns, evaluate a memory of previous interactions and whether the caller can integrate current information into the call.

16. The system of claim 13, wherein the active engagement module further comprises an interruption agent configured to evaluate whether the caller can handle interruptions during the interactive challenges, assessing an adaptability of the caller and continuity in interaction flow.

17. The system of claim 13, wherein the composite score generator is configured to dynamically adjust a weighting of the outputs from the passive detection module and the active engagement module based on predefined criteria, thereby refining an accuracy of the composite synthetic voice detection score.

18. The system of claim 13, wherein the processing system comprises a plurality of processors operating in a distributed computing environment.

19. A non-transitory machine-readable medium, comprising executable instructions that, when executed by a processing system including a processor, facilitate performance of operations, the operations comprising:
receiving an audio input from a voice of a caller;
analyzing the audio input to extract acoustic features, spectral patterns, prosodic elements, and lexical characteristics using passive detection techniques;
actively engaging in a conversation with the caller, wherein the conversation presents an interactive challenge;
receiving responses from the caller to the interactive challenge;
processing the responses to assess response timing, content coherence, and complexity using automatic speech recognition and natural language processing techniques;
combining the passive detection techniques with an evaluation of the responses of the caller to generate a composite synthetic voice detection score; and
based on the composite synthetic voice detection score, determining whether the voice of the caller is generated by artificial intelligence.

20. The non-transitory machine-readable medium of claim 19, wherein the operations further comprise dynamically adjust a weighting of outputs from the passive detection techniques and the interactive challenge based on predefined criteria, to refine an accuracy of the composite synthetic voice detection score.
